(19) United States
(12) Patent Application Publication
(10) Pub. No.: US 2015/0301236 A1
(43) Pub. Date: Oct. 22, 2015

(54) OPTICAL FILTER

(71) Applicant: Sharp Kabushiki Kaisha, Osaka-shi, Osaka (JP)

(72) Inventor: Takashi Nakano, Osaka-shi (JP)

(21) Appl. No.: 14/646,033

(22) PCT Filed: Nov. 29, 2013
(86) PCT No.: PCT/JP2013/082142

§ 371 Date: May 20, 2015

(30) Foreign Application Priority Data
Dec. 6, 2012 (JP) 2012-267489

(51) Int. Cl. G02B 5/00; G02B 5/28

(52) U.S. Cl. CPC G02B 5/008; G02B 5/285

(57) ABSTRACT

An object is to improve wavelength selectivity of an optical filter which selects a wavelength of incident light. Accordingly, an optical filter is the filter that selects a wavelength of incident light and includes a multilayer film which includes three or more thin metal films by alternately laminating each thin metal film and a dielectric film, and apertures which pass through the multilayer film, and are arranged with a period of less than the wavelength of the incident light.

### TECHNICAL FIELD

The present invention relates to an optical filter that selects a wavelength of incident light.

### BACKGROUND ART

Recently, a hole-type optical filter has been proposed in which apertures are periodically arrayed in a thin metal film, and a wavelength is selected by using surface plasmons. In the related art, it has been considered that transmittance of the thin metal film having apertures the diameter of which is a size of less than or equal to a wavelength of light depends on the film thickness, and is less than approximately 1%.

However, as described in PTL 1, when the apertures having a predetermined size are arrayed in the thin metal film with a period according to a wavelength of the surface plasmons, it is found that transmittance of light having a wavelength which induces the surface plasmons is improved considerably.

In addition, in NPL 1 and NPL 2, a technique is disclosed in which transmission spectra of RGB are able to be obtained by using a slit-type optical filter using such surface plasmons. Specifically, a technique is disclosed in which transmission spectra having a wavelength of a blue color, a green color, and a red color are able to be obtained by using the thin metal film periodically having a subwavelength slit structure.

### CITATION LIST

### Patent Literature

PTL 1: Japanese Patent No. 3008931

### Non Patent Literature

NPL 1: Ting Xu et al., “Plasmonic nanoresonators for high-resolution colour filtering and spectral imaging”, Nature Communications, 24 Aug. 2010, pp. 1-5

NPL 2: Chih-Jui Yu et al., “Color Filtering Using Plasmonic Multilayer Structure”, Nanoelectronics Conference (INEC), 2011, pp. 1-2

NPL 3: H. A. Bethe, “Theory of Diffraction by Small Holes”, Physical Review, 1944, Vol. 66, pp. 163-182

NPL 4: H. F. Ghaemi et al., “Surface plasmons enhance optical transmission through subwavelength holes”, Physical Review B, 1998, Vol.58, No. 11, pp. 6779-6782

### SUMMARY OF INVENTION

### Technical Problem

In NPL 1 described above, a periodic slit structure is formed by a MIM structure in which a dielectric film is interposed between the thin metal films, and thus an optical filter depending on a period of slits is realized. Then, white light formed of multi-wavelength light is radiated from a substrate side, and the surface plasmons are induced in a surface of each thin metal film. Accordingly, the surface plasmons and the incident light resonantly interact with each other, and thus a wavelength of transmitted light is selected and intensity thereof is improved. However, in this optical filter, the transmittance is approximately 60% even at a wavelength at which transmittance is maximized.

In addition, in NPL 2 described above, influence of the film thickness of the thin metal film and the dielectric film to the transmitted light is examined in the same structure as that in PTL 1. It is indicated that it is difficult to control the wavelength and the intensity of the transmission wavelength to a great extent (in a case of the wavelength, a change of approximately a few hundred nm, and in a case of the intensity, an increase of a few dozen %) according to the film thicknesses of the thin metal film and the dielectric film.

Thus, when the transmission spectra are used in the optical filter which does not have particularly high transmittance, it is necessary to increase the intensity of incident light in order to ensure the intensity of the transmission spectra. Accordingly, in the case where the optical filter is used in a liquid crystal panel or an image sensor, a sufficient optical intensity may not be obtained. Therefore, realization of an optical filter having high transmittance in a wavelength region including the visible light region has been desired.

An object of the present invention is to improve wavelength selectivity of an optical filter that selects a wavelength of incident light.

### Solution to Problem

In order to attain the object described above, the present invention provides an optical filter that selects a wavelength of incident light and including a multilayer film which has three or more thin metal films by alternately laminating each thin metal film and a dielectric film; and apertures which pass through the multilayer film, and are arranged with a period of less than the wavelength of the incident light.

### Advantageous Effects of Invention

According to the present invention, by arranging predetermined apertures in the optical filter including the multilayer film having three or more thin metal films, the incident light and surface plasmons of the thin metal film are coupled, and thus it is possible to improve wavelength selectivity.

### BRIEF DESCRIPTION OF DRAWINGS

FIG. 1 is a plan view of an optical filter of an embodiment of the present invention.

FIG. 2A is a cross-sectional view of a manufacturing process of the optical filter.

FIG. 2B is a cross-sectional view of the manufacturing process of the optical filter.

FIG. 2C is a cross-sectional view of the manufacturing process of the optical filter.

FIG. 3A is a vertical cross-sectional view of an optical filter of a first embodiment.

FIG. 3B is a plan view of the optical filter of the first embodiment.

FIG. 4A is a vertical cross-sectional view of an optical filter of a comparative example.

FIG. 4B is a plan view of the optical filter of the comparative example.

FIG. 5 is a graph illustrating a relationship between a transmission wavelength and a transmission degree of the optical filter of the first embodiment and the optical filter of the comparative example.

FIG. 6 is a graph illustrating a relationship between a period of slits and a peak wavelength of transmitted light of the optical filter of the first embodiment.

FIG. 7 is a perspective view of a spectroscopic image capturing element, and an enlarged view thereof.

FIG. 8 is a partial cross-sectional view of the spectroscopic image capturing element of FIG. 7.

### DESCRIPTION OF EMBODIMENTS

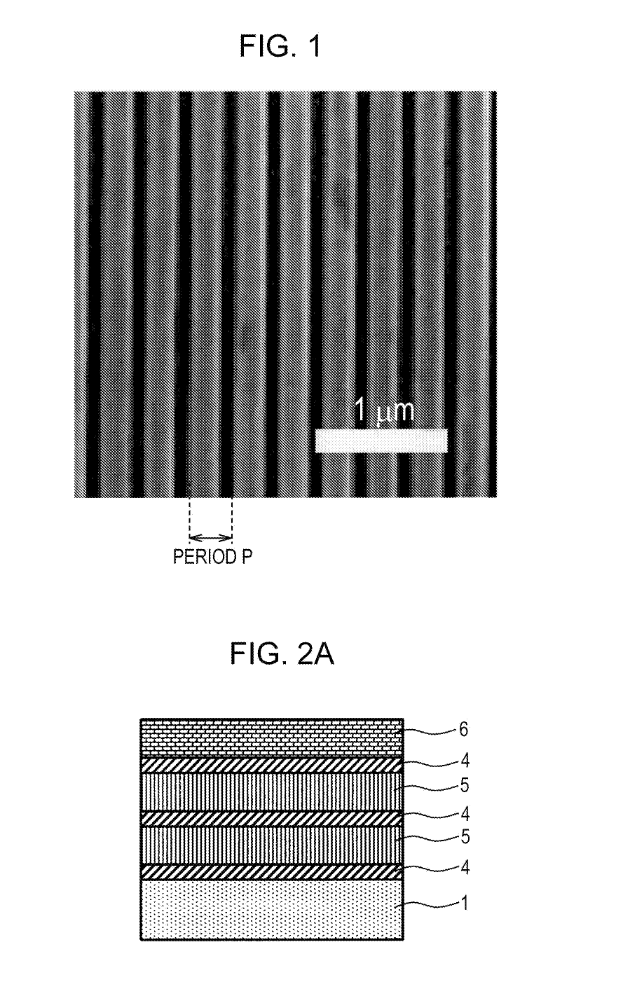

FIG. 1 is a plan view of an optical filter of an embodiment of the present invention. The optical filter includes a multilayer film in which a thin metal film and a dielectric film are alternately overlapped on a flat and smooth substrate. Then, light having a wavelength in the visible region or the near-infrared region is transmitted by fine apertures passing through the multilayer film.

A principle on which metal functions as the optical filter by providing the apertures, that is, slits or a holes having an aperture width sufficiently smaller than the wavelength of incident light will be described in summary as follows.

The slits or the holes having a size smaller than the wavelength of the incident light are periodically formed in the multilayer film, and thus surface plasmons in the thin metal film and the incident light are coupled when the multilayer film is irradiated with the light, and transmission of a specific wavelength increases. Furthermore, here, the “wavelength of the light” indicates a wavelength of light incident on the multilayer film when the optical filter is used. Therefore, the wavelength is able to be changed in a wide range, and in general, is selected from the visible region (380 nm to 750 nm) or the infrared region (750 nm to 1.4 μm).

Furthermore, when a light transmissive substrate is used as a substrate, in order to attain such a transmission degree of an electrode, the transmission degree of the light transmissive substrate is preferably greater than or equal to 80%, and is more preferably greater than or equal to 90%.

Next, a basic principle of the present invention will be described. First, a phenomenon will be described in which light is transmitted through the thin metal film provided with a hole having an aperture radius smaller than the wavelength of the light. In the related art, a phenomenon that occurs in the case of irradiating with light the thin metal film provided with the hole having an aperture radius smaller than the wavelength of the light has been described by a Bethe's theory of diffraction (refer to NPL 3). Assuming that the thin metal film is a perfect conductor, and the thickness is limitlessly thin, an intensity A of completely polarized light being transmitted through an aperture having a radius a smaller than a wavelength λ is denoted by Expression 1. k indicates a wave number of the light (k=2π/λ), and θ indicates an incident angle.

A=[64k⁴a⁶(1−3/ 8sin^{∓}θ)]/27x [Expression 1]

Further, when the intensity A of the light is divided by an area πa2 of the aperture, efficiency η of the transmission light of the light radiated to the aperture is obtained, and thus is denoted by Expression 2. The wave number k is proportionate to an inverse number of the wavelength λ, and thus this expression indicates that the transmission efficiency η of the light is proportionate to the fourth power of (a/λ). Therefore, it is considered that transmission of the light rapidly decreases as the aperture radius a becomes smaller.

η=64(ka)⁴/26n [Expression 2]

However, it has been found that transmittance of the light which is greater than or equal to transmission calculated from the theory described above is able to be obtained by countlessly providing the slits or the holes having an aperture width or radius smaller than the wavelength of the light in the thin metal film. There is described that such an exceptional transmission phenomenon of light occurs due to a resonant interaction between the surface plasmons and the incident light at the time of irradiating metal with the light (refer to NPL 4).

This phenomenon will be described as follows. A relationship between a wave vector of the surface plasmons and the thin metal film having a periodic structure of a square lattice on the surface is represented by Expression 3 from the principle of conservation of momentum.

k̅ₛ̅ₚ̅= k̅ₓ̅+i G̅ₓ̅+j G̅_̅{̅y̅}̅ [Expression 3]

In Expression 3, an element denoted by Expression 4 is a surface plasmon wave vector, an element denoted by Expression 5 is a component of a wave vector of incident light in the surface of the thin metal film, an element denoted by Expression 6 is a reverse lattice vector with respect to a square lattice, P is a period of hole arrays, θ is an angle between the incident wave vector and a surface normal of the thin metal film, and i and j are integers.

k̅ₛ̅ₚ̅ [Expression 4]

k̅ₓ̅=x(2π/λ)sin e [Expression 5]

G̅ₓ̅ and G̅_̅{̅y̅}̅ are G̅ₓ̅= G̅_̅{̅y̅}̅=(2π/P) [Expression 6]

On the other hand, an absolute value of the surface plasmon wave vector is able to be obtained by Expression 7 from a dispersion relationship of the surface plasmons.

$$\vert \overline{{k}_{sp}} \vert = \frac{ω}{c} \sqrt{\frac{{ɛ}_{m} {ɛ}_{d}}{{ɛ}_{m} + {ɛ}_{d}}} \qquad [ Expression 7 ]$$

In Expression 7, ω is an angular frequency of the incident light, εm and εd are respectively specific permittivity of metal and a dielectric medium, and in a case of irradiation from the atmosphere, εd=1. Here, assuming that εm<0 and |εm|>εd, this is a case where metal and a doped semiconductor is irradiated with the incident light of less than or equal to a bulk plasma frequency. When a wave vector of the incident light parallel with a metal surface is 0, and the opened holes are arrayed in the shape of a square lattice, a wavelength at which transmission of perpendicular incidence (θ=0) is a maximum is denoted by Expression 8 by connecting these expressions.

$${λ}_{max} = \frac{P}{\sqrt{{i}^{2} + {j}^{2}}} \sqrt{\frac{{ɛ}_{m} {ɛ}_{d}}{{ɛ}_{m} + {ɛ}_{d}}} \qquad [ Expression 8 ]$$

Similarly, when the opened holes are in the shape of a triangle lattice which is a hexagonal target, the wavelength is denoted by Expression 9.

$${λ}_{max} = \frac{P}{\sqrt{\frac{4}{3} ( {i}^{2} + ij + {j}^{2} )}} \sqrt{\frac{{ɛ}_{m} {ɛ}_{d}}{{ɛ}_{m} + {ɛ}_{d}}} \qquad [ Expression 9 ]$$

In addition, when the slits are opened, the wavelength is denoted by Expression 10.

$${λ}_{max} = \frac{P}{i} \sqrt{\frac{{ɛ}_{m} {ɛ}_{d}}{{ɛ}_{m} + {ɛ}_{d}}} \\ or \\ {λ}_{max} = \frac{P}{j} \sqrt{\frac{{ɛ}_{m} {ɛ}_{d}}{{ɛ}_{m} + {ɛ}_{d}}} \qquad [ Expression 10 ]$$

The wavelength indicating a maximum transmission is a function depending on a period P between the apertures in addition to the permittivity of the metal, and the permittivity of the substrate or the air on the irradiation side. When the conditions described above are satisfied, the incident light and the surface plasmons in the thin metal film are coupled, and as a result thereof, the light having a wavelength is transmitted through a diffraction limit. That is, the aperture structure having a period causes the transmission of light having a specific wavelength according to the period.

According to the principle described above, it is considered that light is transmitted through the thin metal film when the slits or the holes having an aperture width or radius less than or equal to the wavelength of the incident light is arranged in the thin metal film. According to the principle described above, for example, the slits or the holes having an aperture width radius less than or equal to the wavelength of the light to be transmitted are formed over the entire metal surface, and thus the entire metal surface transmits the light.

In the principle described above, only light in the limited wavelength region of white light, that is, only monochromatic light is able to be transmitted by the aperture structure having a single period, and the spectrum of the transmitted light indicates an extremely sharp maximum value. Accordingly, transmittance is extremely low with respect to light having colors other than the white color. In addition, when the film thickness of the thin metal film is thick, properties of bulk metal is noticeable, and plasma reflection occurs, and thus an absolute value of transmittance decreases.

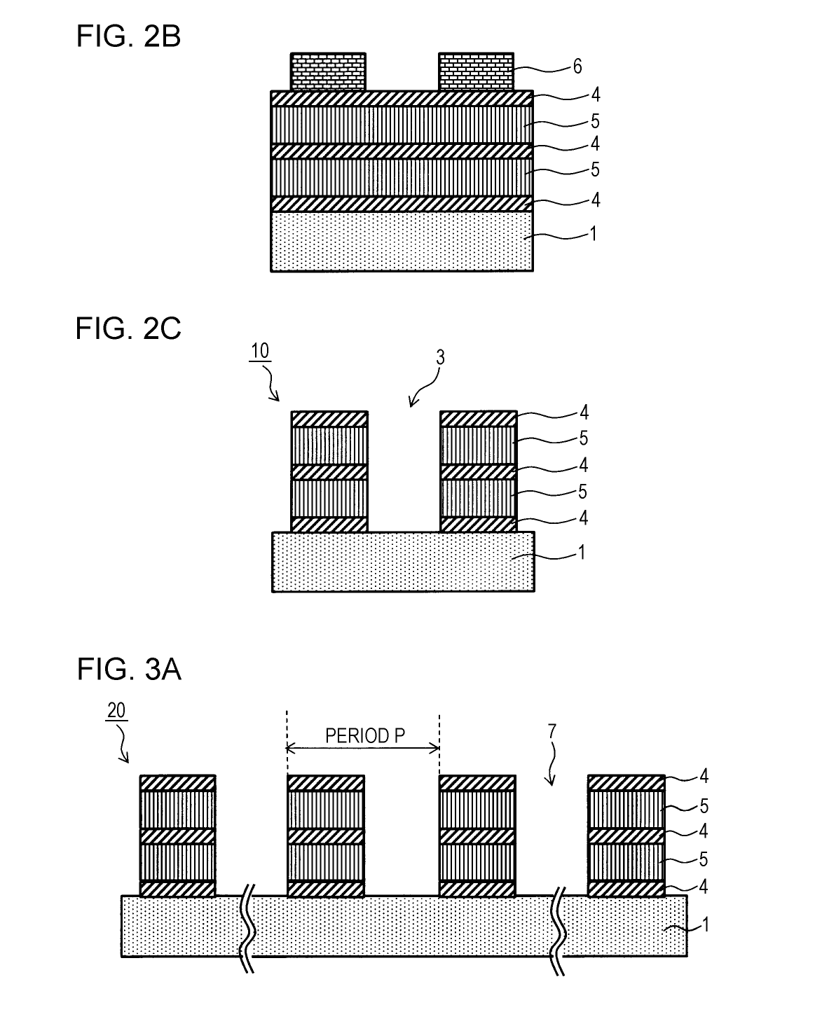

Next, a method for manufacturing the optical filter of an embodiment of the present invention will be described. FIG. 2A to FIG. 2C are cross-sectional views of manufacturing processes of the optical filter. For manufacturing the optical filter, a microfabrication technique such as a photolithography method, an electron lithography method, or a nanoimprint method is able to be used. Furthermore, in a process for making apertures of the optical filter of an embodiment of the present invention formed of a plurality of layers, the plurality of layers may be opened all at one time, or may be opened one by one while positioning the layers.

As illustrated in FIG. 2A, a thin metal film 4 and a dielectric film 5 are alternately laminated on a substrate 1, and an etching mask layer 6 is laminated on the uppermost layer which is used as a mask at the time of forming apertures 3 by etching. In FIG. 2A, three thin metal films 4, and two dielectric films 5 interposed between the thin metal films 4 are formed. Note that the number of thin metal films 4 and dielectric films 5 is not particularly limited insofar as the number of thin metal films 4 is greater than or equal to three, and the lowermost layer and the uppermost layer may be either the thin metal film 4 or the dielectric film 5 insofar as the thin metal film 4 and the dielectric film 5 are alternately laminated.

Next, as illustrated in FIG. 2B, a pattern is transferred to the etching mask layer 6 by a dry etching method. Here, in order to prevent a problem such as side etching, it is preferable that the pattern is transferred in accordance with etching conditions of high anisotropy. At this time, it is necessary that the etching mask layer 6 is not entirely etched. This is because the remaining etching mask layer 6 is a mask for forming the apertures 3.

Next, as illustrated in FIG. 2C, a multilayer film of the thin metal films 4 and the dielectric films 5 is patterned by etching processing. At this time, the etching rate of the etching mask layer 6 is not 0, and thus the etching mask layer 6 is also removed according to the etching of the multilayer film of the thin metal films 4 and the dielectric films 5, and an optical filter 10 including the apertures 3 is obtained.

The substrate 1 is not particularly limited insofar as the substrate 1 is formed of a material which transmits the incident light, and may be any one of an inorganic material, an organic material, and a mixed material thereof. As the substrate 1, for example, glass, quartz, Si, a compound semiconductor, and the like are able to be used. In addition, the size and the thickness of the substrate 1 are not particularly limited. In addition, the shape of the surface of the substrate 1 is not particularly limited, and may be a flat surface or a curved surface.

Furthermore, in consideration of adhesiveness with respect to the thin metal film 4 or the dielectric film 5 formed on the substrate 1, a suitable surface treatment may be performed on the substrate 1, and then the thin metal film 4 or the dielectric film 5 may be laminated. In addition, a transparent material having high resistance to the etching may be laminated on the substrate 1 as a stopper layer, and then the thin metal film 4 or the dielectric film 5 may be laminated.

Metal forming the thin metal film 4 is able to be selected arbitrarily. Here, the metal is a single-element metal which is a conductor, has metal luster, and is a solid at ordinary temperature, and an alloy thereof. It is preferable that a plasma frequency of the material forming the thin metal film 4 is higher than the frequency of the incident light. In addition, it is desirable that absorbance of light is small in a wavelength region of the light to be used. As such a material, for example, aluminum, nickel, cobalt, gold, silver, platinum, copper, indium, rhodium, palladium, chromium, or the like is included, and among them, aluminum, silver, gold, copper, indium, nickel, or cobalt, and an alloy thereof are preferable. However, the material is not limited thereto insofar as the metal has a plasma frequency higher than the frequency of the incident light. In addition, the thin metal film 4 may be sintered by a heat treatment, or a protective film or the like may be formed thereon.

For example, it is preferable that the film thickness of the thin metal film 4 is greater than or equal to 5 nm and less than or equal to 100 nm.

It is preferable that the dielectric film 5 is formed of a high dielectric material, that is, a high refractive index material in consideration of a resonance relationship between the incident light and the surface plasmons described later. As such a material, for example, titanium oxide, copper oxide, silicon nitride, iron oxide, tungsten oxide, ZeSe, or the like is included.

As the etching mask layer 6, a material which transmits the incident light and has high resistance to the etching is able to be used. The material of the etching mask layer 6 is not particularly limited, and may be any one of an inorganic material, an organic material, and a mixed material thereof.

As described above, the thin metal film 4 and the dielectric film 5 are etched such that the etching mask layer 6 remains, and thus when etching selectivity (a ratio of the etching rate of the etching mask layer 6 to the etching rate of the thin metal film 4 and the dielectric film 5, that is, a value which is obtained by dividing the etching rate of the etching mask layer 6 by the etching rate of the thin metal film 4 and the dielectric film 5) between the material of the etching mask layer 6 and the material of the thin metal film 4 and the dielectric film 5 is E₀₁, it is preferable that a combination of the materials having a relationship of 0<E₀₁<1 is used. For example, SiN, Al₂O₃, and the like are able to be used.

Furthermore, instead of the etching mask layer 6, the dielectric film 5 on the uppermost layer may be formed to be thick, and may have a function of a mask at the time of the etching.

A method for forming the thin metal film 4, the dielectric film 5, and the etching mask layer 6 is not particularly limited, and for example, a sputtering method, a vapor deposition method, a plasma CVD method, and the like are able to be used.

The apertures 3 are arranged with a period of less than the wavelength of the incident light. For example, it is preferable that the period with which the apertures 3 are arranged is greater than or equal to 100 nm and less than or equal to 1000 nm. The shape of the apertures 3 is not particularly limited.

In addition, the apertures 3 may be filled with a dielectric substance. At this time, it is preferable that the substance filling the apertures 3 transmits the incident light.

Thus, the apertures 3 are arranged such that the incident light having a predetermined wavelength induces the surface plasmons in the surface of the thin metal film 4, and the surface plasmons and the incident light resonantly interact with each other, and thus the wavelength of the transmitted light is selected and the intensity is improved.

Furthermore, when a nanoimprint method is used for manufacturing the optical filter described above, a nanoimprint stamper is used for forming a pattern in a step of forming the pattern on the etching mask layer 6. By using this nanoimprint stamper, a mask pattern is formed on the etching mask layer 6, and dry etching is performed through the mask, and thus it is possible to form a pattern of the apertures 3.

### First Embodiment

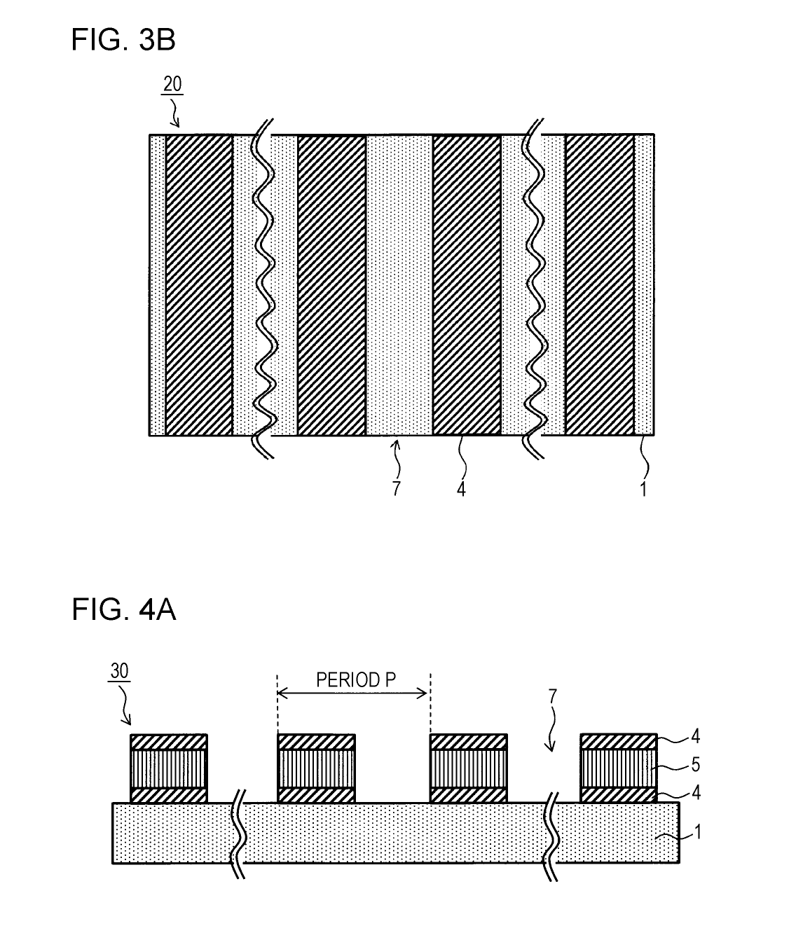

An optical filter provided with a multilayer light transmissive thin metal film which transmits light having a wavelength in the visible region was prepared. A vertical cross-sectional view of the optical filter is illustrated in FIG. 3A, and a plan view thereof is illustrated in FIG. 3B. In a prepared optical filter 20, the thin metal film 4 having a film thickness of 40 nm which was formed of Al, and the dielectric film 5 having a film thickness of 100 nm which was formed of TiO2 were alternately laminated on the substrate 1 formed of glass, and a slit 7 was formed as the aperture. Three thin metal films 4 and two dielectric films 5 interposed between the thin metal films 4 are formed. Such a layer configuration is referred to as a MIMIM structure.

An average aperture width of the slits 7 was 245 nm, and the period with which the slits 7 were arranged was 270 nm.

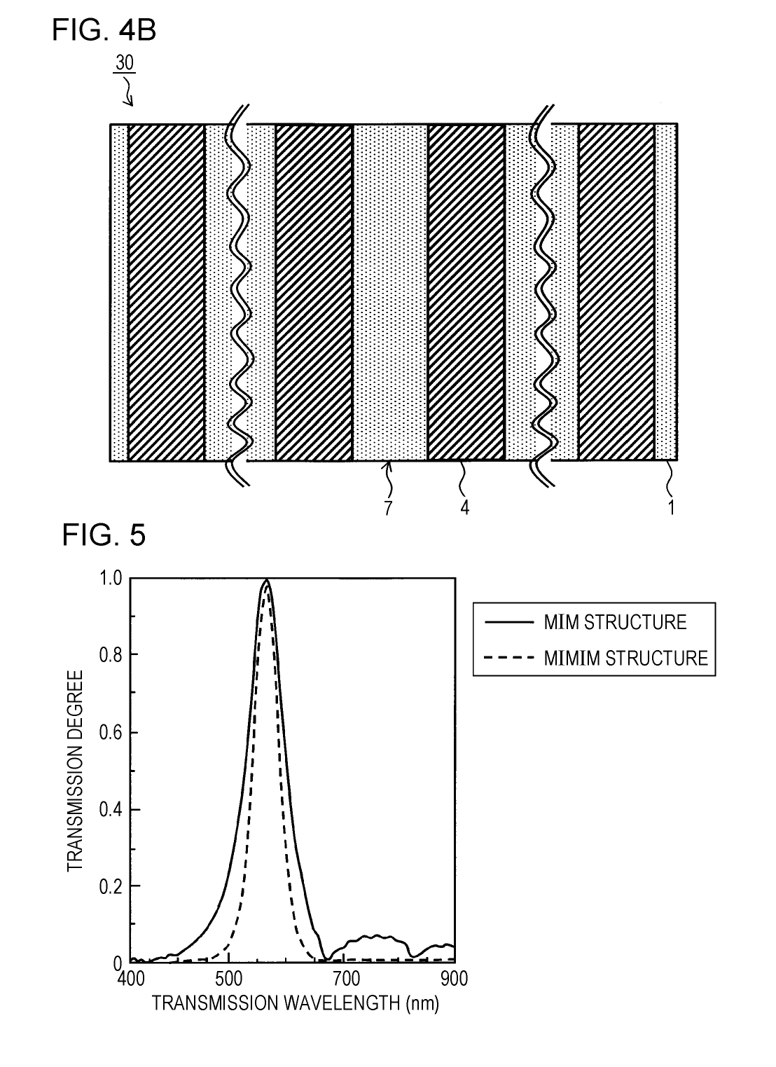

In addition, as a comparative example, an optical filter 30 as illustrated in FIG. 4A and FIG. 4B was prepared. The configuration of this optical filter is identical to that of the optical filter 20 of the first embodiment except that two thin metal films 4 and one dielectric film 5 interposed between the thin metal films 4 were formed. Such a layer configuration is referred to as a MIM structure.

FIG. 5 is a graph illustrating a relationship between a transmission wavelength and a transmission degree of the optical filter 20 of the first embodiment (the MIMIM structure) and the optical filter 30 of the comparative example (the MIM structure). In the optical filter of the first embodiment, it is found that a plurality of MI structures exists along a direction in which the light is incident, and thus the peak of the transmission wavelength and transmittance are rarely changed but selectivity of the transmission wavelength is improved, as compared to the comparative example.

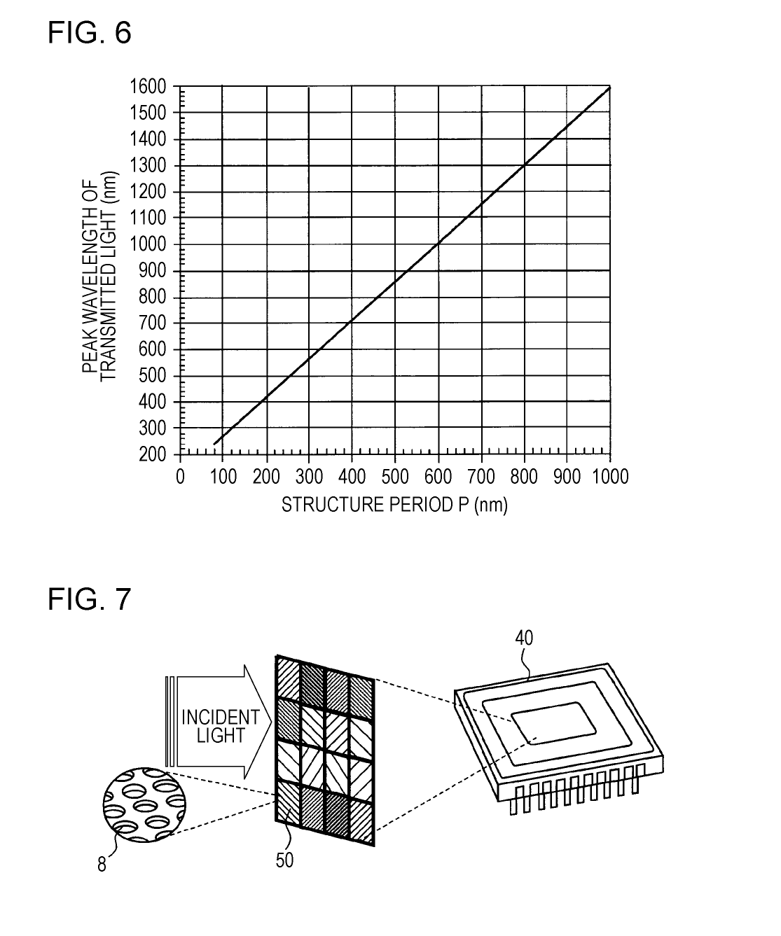

FIG. 6 is a graph showing a relationship between the period of the slits 7 in the optical filter 20 and a peak wavelength of the transmitted light of the first embodiment. It is found that the peak wavelength of the transmitted light is proportionate to the period of the slits 7. Accordingly, by adjusting the period of the slits 7, it is possible to design an optical filter by which transmitted light having a desired wavelength is obtained.

Furthermore, in this example, a structure in which three thin metal films 4 and two dielectric films 5 are alternately laminated is exemplified as the MIMIM structure, but the configuration of the present invention is not limited thereto, and four thin metal films 4 and three dielectric films 5 may be alternately laminated. That is, the same effect is obtained insofar as the thin metal film 4 and the dielectric film 5 are alternately laminated, and the multilayer film includes three or more thin metal films 4.

### Second Embodiment

An optical filter including a multilayer light transmissive thin metal film which transmits light having a wavelength in the visible region was prepared, and this optical filter was disposed on a pixel of an image capturing element, and thus a spectroscopic image capturing element integrated with a spectroscope was obtained. FIG. 7 is a perspective view of a spectroscopic image capturing element 40 and an enlarged view thereof. FIG. 7 illustrates a diagram in which the spectroscopic image capturing element 40, and a plurality of optical filters 50 which is in a partially enlarged view are disposed, and a schematic view in which the surface of the optical filter 50 is enlarged.

The optical filter 50 has a MIMIM structure in which the thin metal film 4 and the dielectric film 5 are alternately laminated on the substrate 1, and have apertures 8 in the shape of a cylinder.

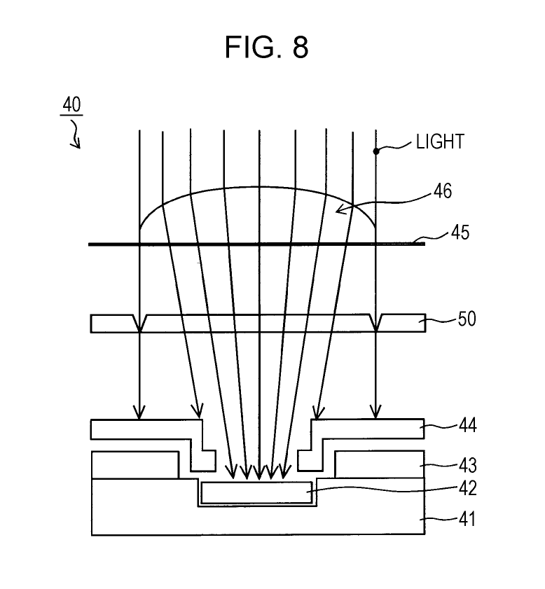

FIG. 8 is a partial cross-sectional view of the spectroscopic image capturing element 40. A light-receiving element 42, an electrode 43, a shielding film 44, an optical filter 50, a planarizing layer 45, and a microlens 46 are disposed on a silicon substrate 41. By disposing the optical filter 50 instead of a color filter which has been provided in the related art, it is possible to obtain the spectroscopic image capturing element 40 in which a wavelength of light received by each pixel is different pixel by pixel. In order to realize the wavelength of light received by each pixel being different pixel by pixel, the period of the apertures 8 is adjusted similarly to the slits 7 described above.

### Third Embodiment

The shape of the aperture is the slit 7 in the first embodiment, and is a cylinder in the second embodiment, but the shape is not limited thereto, and may be a circular cone, a triangular pyramid, a quadrangular pyramid, other arbitrary cylinders or pyramids, or a mixed shape thereof. In addition, even when the apertures having various sizes are mixed, the effect of the present invention is obtained. Thus, in the case where the size of the apertures is not constant, the diameter of the apertures is able to be indicated by an average value.

Hereinafter, the embodiments of the present invention will be summarized. The optical filter 10 is the filter that selects the wavelength of incident light and includes the multilayer film which includes three or more thin metal films 4 by alternately laminating the thin metal film 4 and the dielectric film 5, and the apertures 3 which pass through the multilayer film, and are arranged with the period of less than the wavelength of the incident light.

According to this configuration, the apertures 3 as described above are arranged in the optical filter 10 including the multilayer film having three or more thin metal films, and thus the incident light and the surface plasmons in the thin metal film 4 are coupled, and therefore, it is possible to improve wavelength selectivity.

In addition, in the optical filter 10 described above, it is preferable that the film thickness of the thin metal film is greater than or equal to 5 nm and less than or equal to 100 nm. This range is determined for coupling the incident light and the surface plasmons in the thin metal film 4.

In addition, in the optical filter 10 described above, it is preferable that the period with which the apertures 3 are arranged is greater than or equal to 100 nm and less than or equal to 1000 nm. According to this range, it is possible to design the optical filter 10 which transmits light of a wavelength in the visible region.

In addition, in the optical filter 10 described above, for example, the apertures 3 are able to be in any shape of a cylinder, a circular cone, a triangular pyramid, and a quadrangular pyramid.

In addition, in the optical filter 10 described above, for example, the apertures 3 are able to be the slits 7.

In addition, in the optical filter 10 described above, for example, the thin metal film 4 includes a material selected from a group consisting of aluminum, silver, platinum, nickel, cobalt, gold, silver, platinum, copper, indium, rhodium, palladium, and chromium.

In addition, in the optical filter 10 described above, for example, the dielectric film 5 includes a material selected from a high refractive index material group consisting of titanium oxide, copper oxide, silicon nitride, iron oxide, tungsten oxide, and ZeSe.

In addition, in the optical filter 10 described above, the apertures 3 may be arranged such that the incident light having a predetermined wavelength induces the surface plasmons in the surface of the thin metal film 4, and the surface plasmons and the incident light resonantly interact with each other, and thus the wavelength of the transmitted light is selected and the intensity thereof is improved.

According to the configuration, the incident light and the surface plasmons in the thin metal film 4 are coupled, and thus it is possible to improve wavelength selectivity.

### INDUSTRIAL APPLICABILITY

The optical filter of the present invention is able to be used in a liquid crystal panel, an image sensor, or the like.

### REFERENCE SIGN LIST

10, 20, 50 OPTICAL FILTER

3, 8 APERTURE

4 THIN METAL FILM

5 DIELECTRIC FILM

7 SLIT

1. An optical filter that selects a wavelength of incident light, comprising:
a multilayer film which includes three or more thin metal films by alternately laminating each thin metal film and a dielectric film; and
apertures which pass through the multilayer film, and are arranged with a period of less than the wavelength of the incident light.

2. The optical filter according to claim 1,
wherein a film thickness of the thin metal film is greater than or equal to 5 nm and less than or equal to 100 nm.

3. The optical filter according to claim 1,
wherein the period with which the apertures are arranged is greater than or equal to 100 nm and less than or equal to 1000 nm.

4. The optical filter according to claim 1,
wherein the apertures are slits.

5. The optical filter according to claim 1,
wherein the apertures are in any shape of a cylinder, a circular cone, a triangular pyramid, and a quadrangular pyramid.
